(19) United States
(12) Patent Application Publication
(10) Pub. No.: US 2007/0021085 A1
(43) Pub. Date: Jan. 25, 2007

(54) Adaptive Beamforming For AM Radio

(75) Inventor: Brian William Kroeger, Sykesville, MD (US)

Correspondence Address: Robert P. Lenart;Pietragallo, Bosick & Gordon, One Oxford Centre, 38th Floor, 301 Grant Street, Pittsburgh, PA, 15219, US

(73) Assignee: iBiquity Digital Corporation, Columbia, MD (US)

(21) Appl. No.: 11/188,344

(22) Filed: Jul. 25, 2005

(51) Int. Cl. H04B 1/40; H04B 1/06; H04B 7/00

(52) U.S. Cl. 455/272; 455/269

(57) ABSTRACT

A method of receiving an AM radio signal comprises the steps of: receiving the AM radio signal using a first loop antenna to produce a first received signal, receiving the AM radio signal using a second loop antenna to produce a second received signal, adjusting the relative gains of the first and second received signals to produce adjusted first and second signals, combining the adjusted first and second signals, demodulating the combined adjusted first and second signals, and producing an output signal in response to the demodulated combined adjusted first and second signals. A receiver that operates in accordance with the method is also provided.

### FIELD OF THE INVENTION

This invention relates to radio receivers, and more particularly to AM receivers having beamforming antennas.

### BACKGROUND OF THE INVENTION

It is well-known that radio reception in an interference-limited environment can be improved using adaptive beamforming techniques. These techniques have not been used in commercial broadcast radio receivers, likely because of cost and complexity due to the need for multiple antenna elements and signal processing to compute the adaptive beamforming parameters. Only the switched diversity antenna technique has been commercially employed for FM reception in automobiles using multiple window antenna elements. The switched diversity antenna does not actually perform beamforming, but blindly selects the RF signal from an alternate antenna element when the signal degrades on the present element. For AM reception, automobiles employ either a (FM) whip antenna or a fixed window element(s) of the switched diversity FM antenna. In this case the antenna senses the E-field (electric field) for AM reception, but the AM wavelength is too long for switched diversity or adaptive beamforming to be effective with the electrically short whip elements.

Home receivers generally employ a loop-type H-field (magnetic field) antenna for AM reception. Portable radios use a ferrite loopstick for compactness inside the radio, while home theater systems have provisions for an external loop antenna. Both the ferrite loopstick antenna and the loop antenna are directional, and require the user to position the loop for best reception for each AM station received. The directional characteristic can actually be an advantage since a null can be manually positioned in the direction of an interferer, improving signal reception quality. Since it is generally inconvenient to reposition the radio or loop antenna each time the station is changed, the user often leaves the antenna at some fixed position, limiting the reception possibilities for the user. External AM and FM antennas with improved performance are available; however, these antennas need to be positioned each time the station is changed to achieve the improved performance. Furthermore these antennas require adjustments to tune the frequency or gain for even better performance, which is inconvenient for most users. An automatic adaptive technique would be desirable to achieve potentially optimum performance without user interaction.

This invention provides practical implementation alternatives for an adaptive beamforming antenna for AM reception in automobiles and home receivers.

### SUMMARY OF THE INVENTION

This invention provides a method of receiving an AM radio signal comprising the steps of: receiving the AM radio signal using a first loop antenna to produce a first received signal, receiving the AM radio signal using a second loop antenna to produce a second received signal, adjusting the relative gains of the first and second received signals to produce adjusted first and second signals, combining the adjusted first and second signals, demodulating the combined adjusted first and second signals, and producing an output signal in response to the demodulated combined adjusted first and second signals.

In another aspect, the invention provides a receiver for receiving an AM radio signal, the receiver comprising a first front end circuit for receiving a first signal from a first loop antenna, a second front end circuit for receiving a second signal from a second loop antenna, a gain control for adjusting the relative gains of the first and second signals to produce adjusted first and second signals, a demodulator for demodulating the adjusted first and second signals, and processing circuitry for producing an output signal in response to the demodulated adjusted first and second signals.

The invention also encompasses another method of receiving an AM radio signal. The method comprises the steps of: initializing beamforming parameters to form a predetermined beam pattern, retrieving a signal vector from at least two antenna elements, computing a multidimensional gradient for a predetermined cost function around a most recent set of the beamforming parameters, applying an incremental change to each beamforming parameter as a function of the gradient in a direction to minimize the cost function, combining the signal vectors from the antenna elements as a function of the beamforming parameters, and outputting the combined signal vectors.

In another aspect, the invention provides a method of receiving an AM radio signal, the method comprising the steps of: receiving the AM radio signal using a first loop antenna to produce a first received signal, receiving the AM radio signal using a second loop antenna to produce a second received signal, selecting a first one of the first and second received signals to produce an output, monitoring the quality of the selected received signal, comparing the quality to a predetermined threshold, and if the quality is less than the predetermined threshold, selecting a second one of the first and second received signals to produce the output.

The invention also provides a receiver for receiving an AM radio signal, the receiver comprising a first loop antenna for receiving the AM radio signal to produce a first received signal, a second loop antenna for receiving the AM radio signal to produce a second received signal, a switch for selecting a first one of the first and second received signals to produce an output, and a processor for monitoring the quality of the selected received signal, for comparing the quality to a predetermined threshold, and if the quality is less than the predetermined threshold, for selecting a second one of the first and second received signals to produce the output.

### BRIEF DESCRIPTION OF THE DRAWINGS

FIG. 1 is a schematic representation of a radio receiver connected to a crossed-loop antenna.

FIG. 2 is a plot showing gain magnitude pattern of each loop of the crossed-loop antenna.

FIG. 3 is an omnidirectional gain magnitude pattern using complex combining of crossed loops.

FIG. 4 is a representation of some steered figure-8 patterns achieved by gain combining crossed loops.

FIG. 5 illustrates beamforming with the addition of an E-field element.

FIG. 6 illustrates beamsteering of a cardioid pattern.

FIG. 7 illustrates the power spectrum of a typical AM analog radio signal.

FIG. 8 is a spectral plot of AM radio signals with interferers.

FIG. 9 is a flow diagram of a generic adaptive beamforming algorithm.

FIG. 10 is a flow diagram of an adaptive beamforming algorithm.

FIG. 11 is a plot showing an adaptive beamforming pattern.

FIG. 12 is a graph that illustrates adaptive beamforming parameters.

FIG. 13 shows the suppression of first and second adjacent interferers over an adaptive beamforming period.

FIG. 14 is a functional block diagram of portions of a radio receiver that employs adaptive beamsteering.

### DETAILED DESCRIPTION OF THE INVENTION

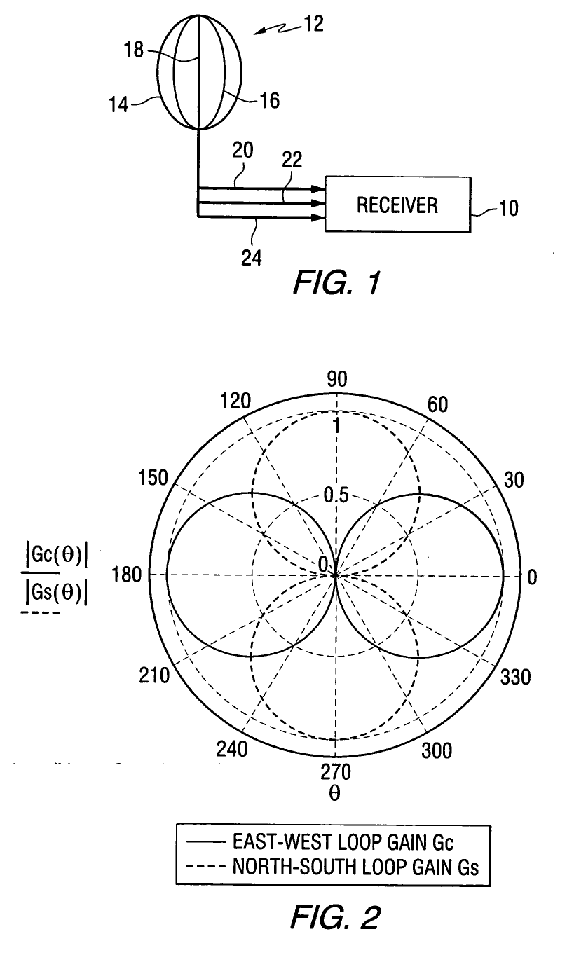

FIG. 1 is a schematic representation of a radio receiver 10 connected to a crossed-loop antenna 12. The crossed-loop antenna includes a first loop element 14 and a second loop element 16 oriented such that the planes of the loop elements are substantially perpendicular to each other. An optional whip antenna element 18 is positioned along the intersection of the planes of the loop elements. The crossed-loop antenna is simply a pair of loop antennas oriented orthogonally to each other. While single loops are illustrated in FIG. 1, the antenna could also be constructed using ferrite loop antenna elements. Signals from the antenna elements are coupled to the receiver on lines 20, 22 and 24. The receiver processes the signals in accordance with this invention.

If a whip element is used with the pair of crossed loops, then the whip should ideally be oriented vertically in the center and possibly above the crossed loops. However, due to the long wavelengths at AM frequencies, the whip may be placed within a few feet of the crossed loops with little degradation. This placement may also be advantageous in reducing interaction between the elements.

The crossed-loop antenna has been widely used in direction finding, and is an excellent candidate for the antenna in an adaptive beamforming application for an AM receiver. Each loop is most sensitive to the signal in a plane of the loop, or at the ends of the ferrite loop. The sensitivity, or (voltage) gain G(θ), in any angular direction is proportional to the cosine of the angle θ from the direction of peak gain. The receiver does not need to determine θ because the adaptive algorithm simply adjusts the parameters to get the best signal.

Note that complex voltage gain is used here instead of power gain. That is,
G(θ)=C·cos(θ); where C is a constant.

The gain pattern (normalized to a maximum value of 1) of a pair of crossed loops is shown in FIG. 2, where zero degrees is arbitrarily defined in Cartesian coordinates (polar representation) in the East direction. Each loop has a figure-8 sensitivity characteristic, and it should be noted that signals from two main lobes of the loop (front or back of the plane of the loop) are inverted relative to each other. This polarity is inherent in the cosine function.

Appropriate combining of the signal from each of the loops allows the directional pattern to be adjusted. Simple selection of either of the two loops allows a form of switched diversity, similar to FM switched diversity antennas. In this case the antenna uses the H-field (magnetic field) for AM reception instead of the E-field (electric field) because the AM wavelength is too long for switched diversity or adaptive beamforming to be effective with the electrically short E-field antenna elements. However switched diversity can be effective using the pair of directional crossed H-field loop elements. A single or pair of crossed-loop elements would not suffice as an AM antenna for a conventional receiver (without beamsteering or beamforming) because the nulls in the directional pattern would prevent signal reception for some orientations of the vehicle. However a switched selection diversity algorithm between the crossed-loop elements allows a much simpler modification option to conventional receiver having a single front end. The performance is not as good as with the adaptive beamforming techniques described below, but this allows a modified conventional receiver to be used in a car equipped with the crossed-loop antenna.

In a simple switched diversity algorithm, the receiver can include a processor that monitors and estimates some characteristic(s) of the signal, such as signal-to-noise, or signal-to-interference ratio (similar to methods to be presented below). When the signal quality on the presently selected loop falls below some predetermined threshold, the receiver blindly switches to the alternate loop element anticipating that the signal will be better. Some conditioning of the selection process, such as filtering (smoothing) and hysteresis is useful in minimizing excessive switching action, which could degrade performance.

While simple switched diversity is one possibility, more flexibility is possible by adjusting the relative phases and magnitudes of the two signals before combining, offering a range of directional patterns. This allows the possibility of steering the main lobe toward the signal of interest (SOI) and/or steering a null toward an interferer. An omnidirectional (doughnut-like) sensitivity pattern is also possible, requiring no steering.

A third antenna element can also be added for more beamforming flexibility. This optional third element can be an omnidirectional E-field whip antenna, such as is normally used for FM reception. This third element can modify the figure-8 pattern toward a cardioid shape, or anything in between. Both the effects of combining parameters on directional patterns (beamforming) as well as the adaptive beamforming techniques to automatically maximize reception performance are of interest for this invention.

In general the signals from the two loops can be combined after the complex weights a and b are applied to the East-West loop output Gc, and the North-South loop pattern output Gs, where the North-South loop pattern output is adjusted by 90 degrees due to its orthogonal orientation. Then,

$$\begin{matrix}G ( θ ) = a \cdot Gc ( θ ) + b \cdot Gs ( θ ) \\ = a \cdot cos ( θ ) + b \cdot sin ( θ ) .\end{matrix}$$

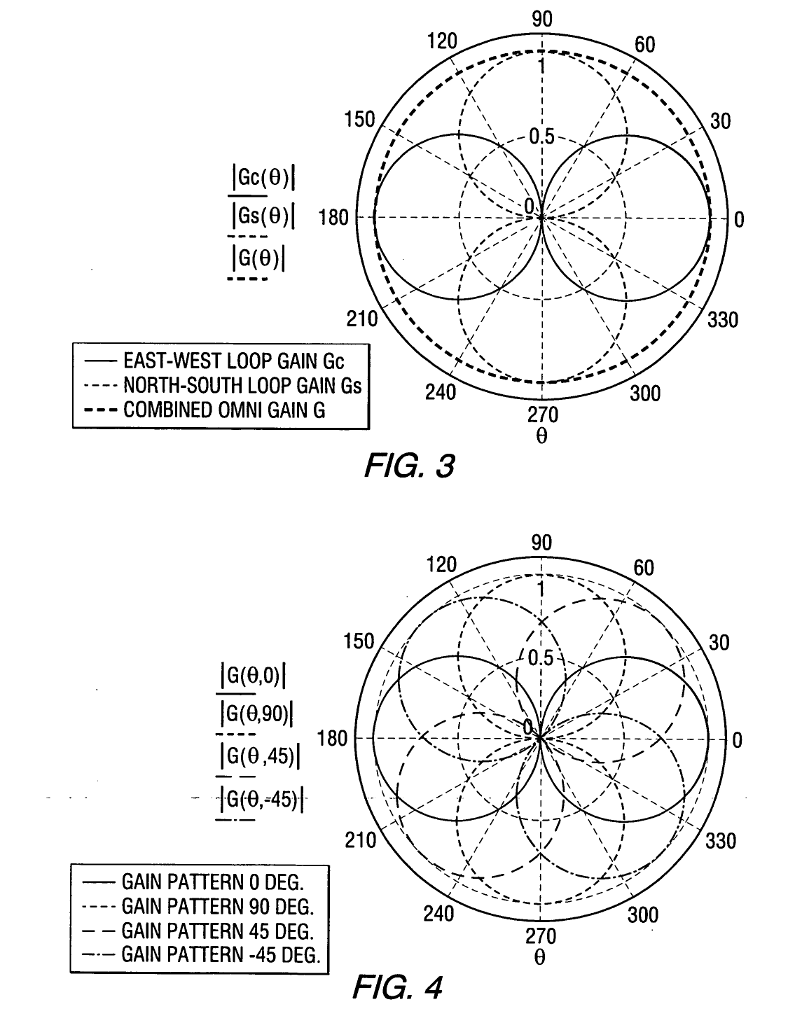

FIG. 3 shows an omnidirectional gain magnitude pattern using complex combining of crossed-loop patterns, or E-field antenna pattern. For an omnidirectional pattern, consider the special case where a and b are chosen to produce the omnidirectional pattern (gain=1). Shifting the relative phase of the two loop signals by 90 degrees before combining yields the desired result. Then one possible solution is
Let a=1, and b=\sqrt{−1}=j
Then G(θ)=cos(θ)+j·sin(θ)=e^{j·θ}
and |G(θ)|=1.

Although the signal gain is complex and shifts the complex signal by angle θ (the angle of arrival) in this case, this arbitrary angle is either removed or is irrelevant at the receiver. The magnitude of the combined omnidirectional gain is 1, as shown in FIG. 3. This omnidirectional pattern is also characteristic of the E-field whip antenna, although the E-field antenna does not shift the signal phase as a function of the angle of arrival.

A steerable figure-8 pattern can be formed by adjusting only the relative gains of the crossed-loop elements. This pattern can be steered over a range of 360 degrees without phase shifting. An expression for the combined antenna gain pattern can be derived as a function of the desired pointing angle φ. The steered figure-8 pattern with its trigonometric equivalent is
G(θ, φ)=cos(θ−φ)=cos(θ)·cos(θ)+sin(θ)·sin(θ) then G(θ, φ)=cos(θ)·Gc(θ)+sin(θ)·Gs(θ) a=cos(θ); b=sin(θ).

The gain pattern of the crossed-loop antenna can be varied over a virtual continuum from an omnidirectional pattern to a figure-8 pointing at any direction. Although the omnidirectional pattern requires no steering, the most beneficial pattern is realized from the figure-8 pattern since nulls can be steered in the direction of interferers. FIG. 4 shows some steered figure-8 patterns achieved with gain combining of crossed loops. The adaptive beamsteering algorithm can be implemented using the preformed figure-8 pattern using only a single control parameter φ, the desired pointing angle. Then there is no need for phase shifting of the loops toward an omnidirectional characteristic, and the relative gains can simply be varied during beamsteering.

Beamforming can be used to improve performance with increased complexity. It is further possible to include an E-field element (for example, a whip element) to form a 3-element adaptive array offering more control over the beamforming.
G(θ, φ, E)=cos(θ″φ)=a·cos(θ)+b·sin(θ)+E
where a=cos(θ), b=sin(θ), and E is the E-field element weight.

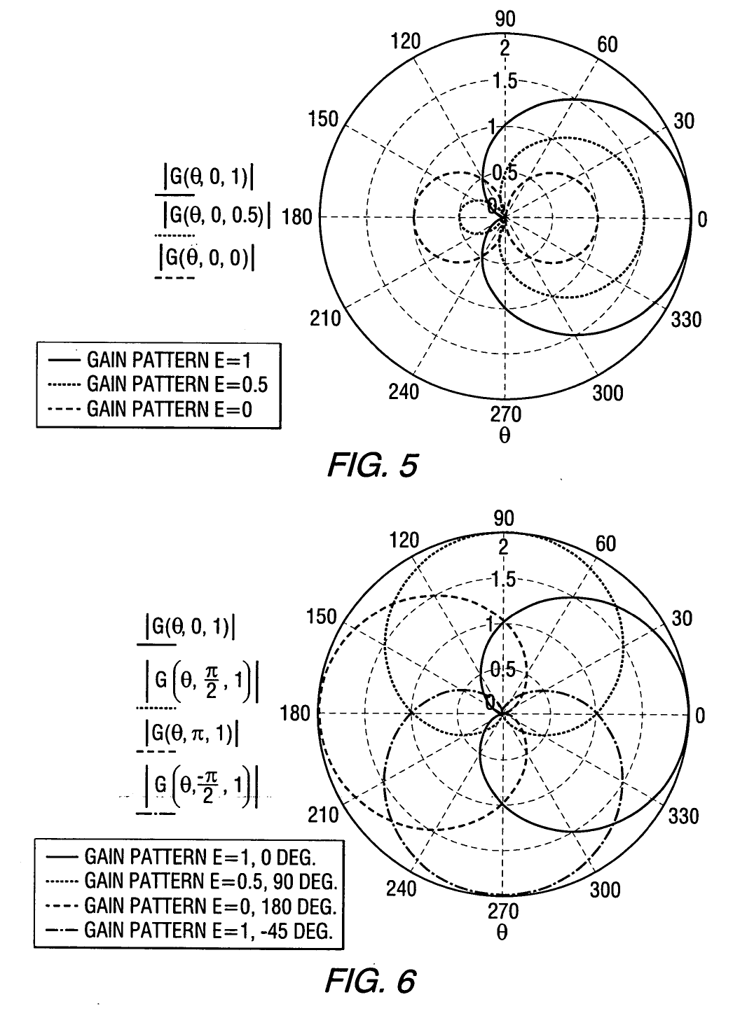

It is assumed here that the peak gains of the three elements (two loops and a whip) are normalized to unity. FIG. 5 shows beamforming with the addition of an E-field element.

In this embodiment, a steerable pattern is achieved as a function of only two parameters, φ and E. A cardioid shape is achieved with E=1, and other shapes between a figure-8 and a cardioid are formed by −1≦E≦1 as shown in FIG. 5. This beam pattern can be steered in any direction p as shown in FIG. 6.

For the AM radio receiver of interest in this invention, at least two implementation alternatives are possible for beamforming. The most straightforward method is to use a pair of analog front-ends that are matched in tuning (e.g., using a common local oscillator and tuning) and automatic gain control (AGC) characteristics (using a common control signal). The signals from each loop are sampled with separate A/D converters, and then combined digitally using a beamsteering algorithm control. This method allows for flexibility and the possibility of digital correction of analog errors.

In a second method the beamsteering algorithm uses a single conventional receiver front-end and digital demodulator. The crossed-loop antenna elements are combined using analog circuitry, which forms the steerable figure-8 pattern. The analog gain control for each element can be output from a digital-to-analog (D/A) pair; however, it is important that the analog gain control is capable of both positive and negative gains (e.g., −1<gain<1) for each loop.

For the AM radio signals of interest in this invention, the baseband received and carrier-synchronized AM signal r(t) can be modeled as a main carrier with amplitude a(t), amplitude modulation m(t), hybrid digital components d(t) if any, interference q(t), and noise n(t).
r(t)=a(t)·[1+m(t)]+d(t)+q(t)+n(t).

For this description, the interferer q(t) is assumed to be either 10 kHz or 20 kHz away from the main carrier frequency. A cost function is needed to discriminate between the desired signal and the interferers. Lowpass filtering of r(t) will yield a local estimate of a(t). Similarly, bandpass filtering around ±10 kHz or ±20 kHz will yield an estimate of the interference. The elements from each signal are then processed and combined using an adaptive algorithm to form the desired beam shape.

Adaptive beamforming control is used to automatically adjust the beam pattern to achieve better reception characteristics. When training symbols or signals are available, adaptive algorithms such as LMS (least mean squares) or RLS (recursive least squares) algorithms can be used. However, the desired performance can be achieved with a simpler blind adaptive method described next, which is robust for analog and in-band on-channel (IBOC) hybrid and digital AM modes.

Blind adaptive methods are used when no training signals are assumed to be available for adaptation. One blind adaptive algorithm is the Constant Modulus Algorithm (CMA). The CMA uses a characteristic of the signal as a parameter for adjusting the beam pattern, or element gains. The constant modulus characteristic can be described, for example, as an FM signal where its amplitude is constant, but its phase or frequency carries the modulated information. The CMA attempts to iteratively adjust the antenna pattern to minimize a cost function, such as the received signal's error magnitude relative to a constant magnitude (envelope). A different cost function is proposed here for AM beamforming. More insight can be gained by examining the AM signal and its spectrum in the presence of interferers.

The AM signal s(t) contains a carrier component, which is amplitude-modulated with the analog audio signal m(t) such as
s(t)=[1+m(t)+d(t)]·e^{j·2·π·fc·t}
where the baseband carrier component is represented as 1, m(t) is the analog audio signal, d(t) represents an optional complex digital component such as the digital sidebands for an HD Radio™ signal, and the baseband signal is shifted to its RF frequency fc. As used herein, s(t) is the clean signal from the transmitter, whereas r(t) is the same but noisy received signal, possibly contaminated with interferers as described below. An AM HD Radio™ signal is described in U.S. Pat. No. 6,898,249, which is hereby incorporated by reference.

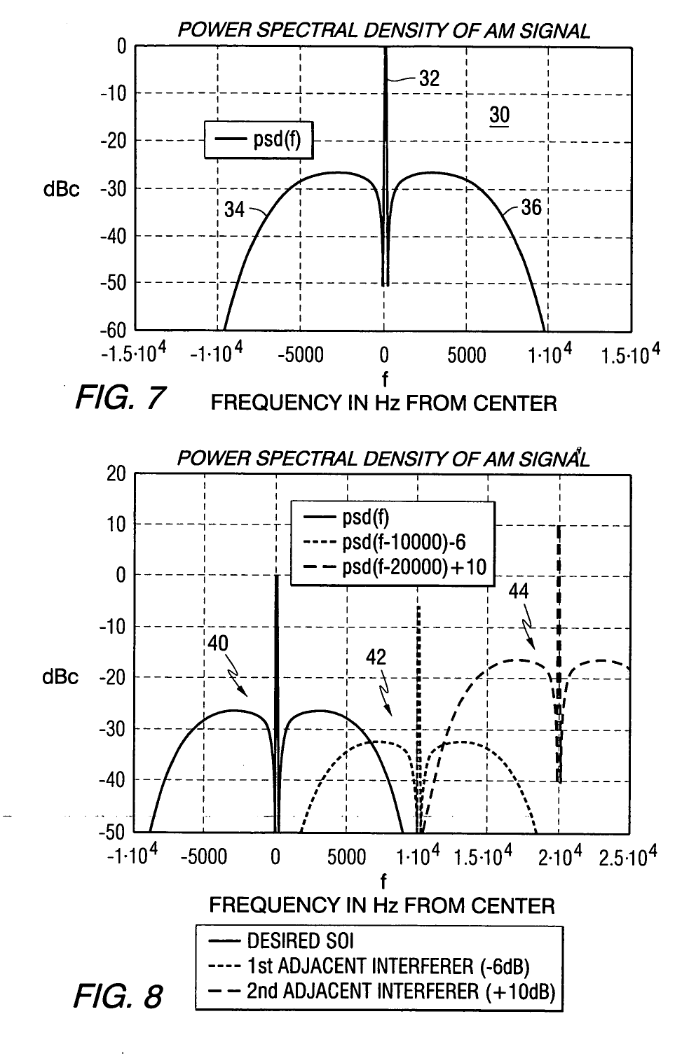

FIG. 7 shows the power spectrum of a typical AM analog signal 30. The spectrum of this AM signal shows the main carrier 32 at 0 dBc in the center with its modulation sidebands 34, 36. It is assumed here that the receiver has translated the RF carrier frequency to zero Hz, resulting in a complex baseband signal.

FIG. 8 shows a spectral plot of an AM signal 40 with interferers 42, 44. Of particular interest is a signal of interest (SOI) 40 in the presence of first and second adjacent interferer signals 42, 44. In FIG. 8, the received signal is expressed as
r(t)=s₀(t)+0.5·s₁(t)·e^{j·2·π·10000·t}+3.16·s₂(t)·e^{j·2·π·20000·t}.

A useful and practical cost function for AM adaptive beamforming involves the minimization of the relative main carrier levels of the interfering signals at ±10 kHz and ±20 kHz from the center frequency. One reliable method for detecting the presence and relative level of a first or second adjacent interferer is to measure the power in a narrow bandwidth (e.g. ±100 Hz) around ±10 kHz or ±20 kHz from the center frequency. This can be accomplished through a mixing and integration process. More useful is the relative power of the interference signal at frequency f₁, where f₁ is usually ±10 kHz or ±20 kHz. This is labeled as the Interference-to-Signal Ratio, or ISR.

$$ISR ( {f}_{I} ) = \frac{{\vert \int r ( t ) \cdot {ⅇ}^{- j \cdot 2 \cdot π \cdot {f}_{I} \cdot t} \cdot ⅆ t \vert}^{2}}{{\vert \int r ( t ) \cdot ⅆ t \vert}^{2}} ,$$

or more practically expressed as a function of a digitally sampled signal

$$ISR ( {f}_{I} ) = \frac{{\vert {\sum }_{n = 0}^{N - 1} {r}_{n} \cdot {ⅇ}^{- j \cdot 2 \cdot π \cdot {f}_{I} / fs} \vert}^{2}}{{\vert {\sum }_{n = 0}^{N - 1} {r}_{n} \vert}^{2}} .$$

The time span of the integration or summation is roughly the reciprocal of the desired bandwidth of the carrier measurement. For example, in an HD Radio™ receiver, the received signal is sampled at approximately fs=45,512 Hz to produce a signal vector. If 270 samples are used in the computation, then the measurement bandwidth is about 172 Hz. A window function may be applied to the received signal vector before the measurement computation to reduce the filter frequency sidelobe levels.

The ISR should ideally include the noise for interferers at ±10 kHz as well as ±20 kHz. Then the complex exponentials in the ISR expression can be modified as

$$ISR ( {f}_{I} ) = \frac{{\vert {\sum }_{n = 0}^{N - 1} {r}_{n} \cdot {cosvect}_{n} \vert}^{2}}{{\vert {\sum }_{n = 0}^{N - 1} {r}_{n} \vert}^{2}} .$$

where cosvectₙ=cos(2·π·n·10000/fs)+c·cos(2·π·n·20000/fs).

The new vector is simply the trigonometric equivalent of the sum of the complex exponentials at ±10 kHz and ±20 kHz, with a factor c (e.g., c=0.5) to desensitize the second adjacent degradation relative to a first adjacent interferer, since the first adjacent interference is more detrimental to performance than the second adjacent interference at the same level. This forces the beamforming of the adaptive algorithm to attenuate the first adjacent interference more than the second adjacent interference when both are present.

The desensitizing factor c may be adjusted in the case of a conventional analog signal or a Hybrid IBOC signal. Since first adjacent interference is always more detrimental than second adjacent interference, c should never be greater than 1. However Hybrid IBOC signals are more sensitive to second adjacent interference than conventional analog signals so the value of c may be set larger for an IBOC interferer than for an analog interferer. Further improvements may be attainable by estimating the relative values of multiple interferers and adjusting a different independent value of c for each interferer (e.g. −20, −10, +10, +20 kHz locations could use c1, c2, c3, c4), depending on the interferer combinations.

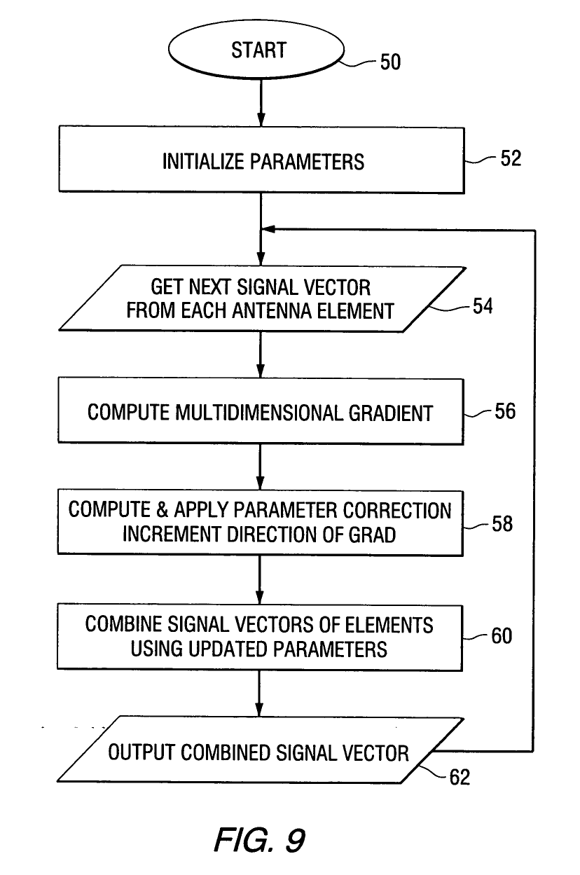

The goal of an adaptive beamforming algorithm is to iteratively and incrementally adjust the beamforming parameters in the direction of minimizing the cost function. A multidimensional gradient is computed for the cost function, where each dimension represents a different beamforming parameter. The 2-element crossed-loop antenna actually has one adjustable parameter φ if the phase component is not adjustable. This single parameter is the angle for steering the figure-8 pattern. An additional phase parameter would not only allow the beam pattern to approach an omnidirectional shape, but more practically since the phase parameter is needed to correct component tolerances that cause a phase difference between the two loop signals. A third parameter is needed if the E-field element (whip antenna) is used, and a fourth parameter is needed to correct its phase error. A generic beamforming algorithm flow diagram is presented in FIG. 9.

The beamforming algorithm starts at block 50 by initializing the parameters that would form a predetermined, but uncalibrated, beamforming pattern. The signal received by each antenna element is sampled and a signal vector is collected from each antenna element, as shown in block 54. The number of samples is the same for each element, and the samples are assumed to be synchronized in time across the elements. A multidimensional gradient (block 56) is computed for the predetermined cost function around the most recent set of parameters. This multidimensional gradient represents the sensitivity and direction (e.g., polarity) of the cost function with respect to a change in value of each parameter. An incremental change (block 58) is applied at each iteration to each parameter as a function the gradient in the direction of minimizing the cost function. This increment can be proportional to the gradient, or limited to some value in the direction of the gradient. Limiting the value of the parameter increments can be used to ensure stability or limit sensitivity to signal levels. The signal vectors from the antenna elements are combined (block 60) as a function of the updated parameters to produce an output signal vector. This signal vector is output (block 62) to the receiver for subsequent processing, and the iteration is then repeated.

The expression for the beamforming control is described next. The general expression for combining the signal vectors Lc and Ls from the pair of H-field crossed-loop elements, plus a whip E-field element Whip to form an output signal vector sigout is
sigout=r(φ, E, phs, phc)=cos(θ)·Lc·e^{j·phc}+sin(θ)·Ls·e^{j phs}+E·Whip.

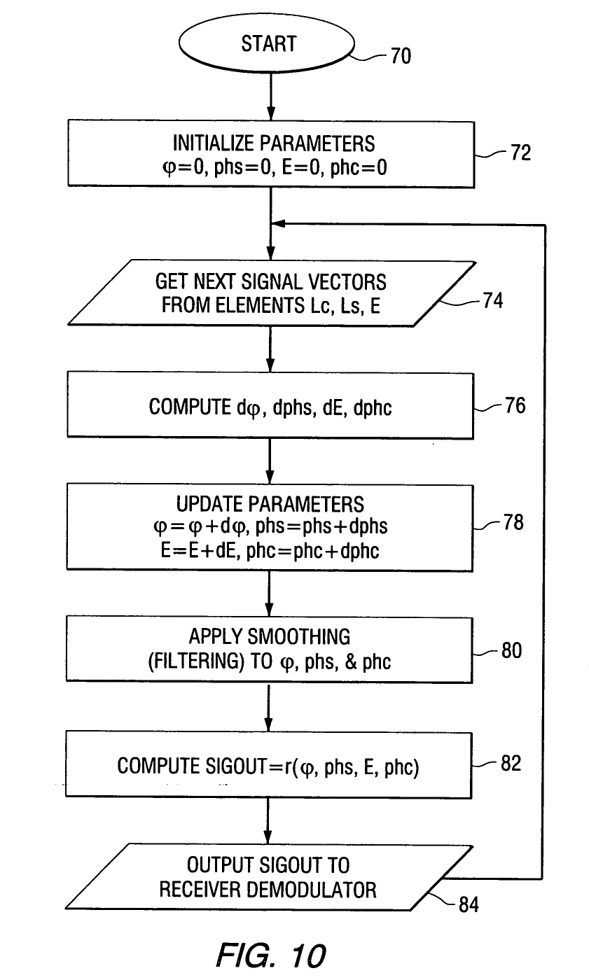

FIG. 10 shows a flow chart of the adaptive beamforming algorithm. The parameters are defined as follows:

φ=steering angle for crossed loop combining, modulo 2π radians.

E=gain of E-field whip antenna element, −1≦E≦1.

phs=phase correction for loop Ls signal, modulo 2π radians.

phc=phase correction for loop Lc signal, modulo 2π radians.

The process starts in block 70 and initializes all parameters to zero as shown in block 72. This is equivalent to starting with only one signal component, sigout=Lc, resulting in the figure-8 pattern. Any phase errors are irrelevant for this initial condition. The signals from each antenna element are sampled to produce signal vectors, as shown in block 74.

An appropriate cost function is needed as a metric for adjusting the parameters toward the beamshape that minimizes the cost function. This cost function is ideally related to the relative levels of the desired and interfering signals, as well as the SNR of the desired signal. One such cost function that is useful in computing the gradient for any of the parameters is the change in interference-to-signal ratio (ISR). This is approximated by estimating the derivative of the ISR evaluated around the present parameter value with respect to each of the adaptable parameters. Start by approximating the partial derivative with a differential for parameter φ (block 76).

$$\frac{\partial ( ISR )}{\partial ϕ} ≅ \frac{Δ ISR}{Δ ϕ} = \frac{ISR ( ϕ + Δϕ / 2 ) - ISR ( ϕ - Δϕ / 2 )}{Δϕ} .$$

Substituting the formula for the ISR, the expression becomes

$$\frac{Δ ISR}{Δϕ} = \frac{{\vert {\sum }_{n = 0}^{N - 1} {r ( ϕ + Δϕ , E , phs , phc )}_{n} \cdot cos {vect}_{n} \vert}^{2}}{Δϕ \cdot {\vert {\sum }_{n = 0}^{N - 1} {r ( ϕ + Δϕ , E , phs , phc )}_{n} \vert}^{2}} - \frac{{\vert {\sum }_{n = 0}^{N - 1} {r ( ϕ - Δϕ , E , phs , phc )}_{n} \cdot cos {vect}_{n} \vert}^{2}}{Δϕ \cdot {\vert {\sum }_{n = 0}^{N - 1} {r ( ϕ - Δϕ , E , phs , phc )}_{n} \vert}^{2}} .$$

This differential value indicates the direction and sensitivity of the ISR to a change in φ about its present value. Since the derivative is not constant over the range of possible values of φ, it is not possible to completely correct the next value of φ such that the derivative around this next value is zero. Furthermore, noise and varying signal levels due to modulation of the carriers results in an error component for any individual computation. Therefore the next value of φ is changed by only a small increment in the direction of this derivative. The magnitude of the noise component relative to the magnitude of the derivative can be made smaller by increasing the value of Δφ in the differential computation, although this is limited due to the nonlinearity of the cost function around its present value. So the value of Δφ in the computation must be a compromise between the accuracy of φ and the other error components. Simulation results and knowledge of the beamforming patterns indicate that a value of about ±5 degrees works reasonably well over the range of signal conditions.

The parameter increment value dφ for the next iteration should be less than Δφ, so it must be explicitly limited. Simulation results indicate that using only the polarity of the differential computation resulting in fixed step sizes ±dφ, where dφ is a predetermined constant (e.g., less than 1 degree), yielded good performance in noise and varying signal conditions. This also simplifies the computation and ensures insensitivity to impulsive noise and large signals, while tracking typical vehicle turning rates. This results in the simplified computation for dφ.

$$d φ = 0.005 \cdot sign [ \begin{matrix}{\vert {\sum }_{n = 0}^{N - 1} {r ( ϕ - Δϕ , E , phs , phc )}_{n} \cdot cos {vect}_{n} \vert}^{2} \cdot {\vert {\sum }_{n = 0}^{N - 1} {r ( ϕ + Δϕ , E , phs , phc )}_{n} \vert}^{2} - \\ {\vert {\sum }_{n = 0}^{N - 1} {r ( ϕ + Δϕ , E , phs , phc )}_{n} \cdot cos {vect}_{n} \vert}^{2} \cdot {\vert {\sum }_{n = 0}^{N - 1} {r ( ϕ - Δϕ , E , phs , phc )}_{n} \vert}^{2}\end{matrix} ] .$$

The value of φ is updated at each iteration to φₙ=φₙ₋₁+dφₙ. The value of dφ in this expression is ±0.005 radians, or roughly ±0.3 degrees. This value was shown to yield good performance in the simulation. The adaptive algorithm continues to update φ at each iteration in the direction toward minimizing the ISR, until the derivative approaches zero. This maximizes the signal-to-interference ratio (SIR), the reciprocal of ISR. However this is not always sufficient to maximize the signal-to-noise and interference ratio, SNIR, which is a better goal to maximize receiver performance. For example consider the case when the desired signal and the interferer are closely spaced in azimuth angle. The adaptive algorithm will attempt to steer a null in the direction of the interferer, which will also attenuate the desired signal. When the interferer level is relatively small, the loss in SNR can be more costly than the degradation due to the interferer. Therefore the computation for dφ should also include the effects of noise, resulting in a balance or compromise of interference and noise degradation. The following expression performs the appropriate beamforming with the goal of maximizing SNIR, not just SIR.

$$d φ = 0.005 \cdot sign [ \begin{matrix}{\vert {\sum }_{n = 0}^{N - 1} {r ( ϕ - Δϕ , E , phs , phc )}_{n} \cdot cos {vect}_{n} \vert}^{2} \cdot {\vert {\sum }_{n = 0}^{N - 1} {r ( ϕ + Δϕ , E , phs , phc )}_{n} \vert}^{2} - \\ {\vert {\sum }_{n = 0}^{N - 1} {r ( ϕ + Δϕ , E , phs , phc )}_{n} \cdot cos {vect}_{n} \vert}^{2} \cdot {\vert {\sum }_{n = 0}^{N - 1} {r ( ϕ - Δϕ , E , phs , phc )}_{n} \vert}^{2} + \\ 0.01 \cdot [ {\vert {\sum }_{n = 0}^{N - 1} {r ( ϕ + Δϕ , E , phs , phc )}_{n} \vert}^{4} - {\vert {\sum }_{n = 0}^{N - 1} {r ( ϕ - Δϕ , E , phs , phc )}_{n} \vert}^{4} ]\end{matrix} ] .$$

The last term in the expression represents the difference in power (squared) over the differential value of the parameter. It is attenuated by a value of 0.01 (experimentally determined for these particular parameter settings) to account for the relative degradation of interference versus noise.

The parameters are updated as shown in block 78 of FIG. 10. A single adaptive parameter φ is sufficient for the case of two crossed-loop elements with no phase error between them. However, phase error, i.e. phs, between the pair of received signal vectors will prevent the possibility of deep nulls for interference suppression. Manufacturing and practical tolerances of the analog front end components will likely result in significant phase error that should be adaptively removed within the algorithm. In this case it is necessary only to adapt the relative phase of the loops since the absolute phase is irrelevant, then only one loop phase (e.g. phs) is adaptive. A method similar to that used for the beamsteering of the crossed loops can also be used to adaptively correct the phase error.

$$dphs = 0.003 \cdot sign [ \begin{matrix}{\vert {\sum }_{n = 0}^{N - 1} {r ( ϕ , E , phs - Δ phs , phc )}_{n} \cdot cos {vect}_{n} \vert}^{2} \cdot {\vert {\sum }_{n = 0}^{N - 1} {r ( ϕ + Δϕ , E , phs , phc )}_{n} \vert}^{2} - \\ {\vert {\sum }_{n = 0}^{N - 1} {r ( ϕ , E , phs + Δ phs , phc )}_{n} \cdot cos {vect}_{n} \vert}^{2} \cdot {\vert {\sum }_{n = 0}^{N - 1} {r ( ϕ , E , phs - Δ phs , phc )}_{n} \vert}^{2} + \\ 0.01 \cdot [ {\vert {\sum }_{n = 0}^{N - 1} {r ( ϕ , E , phs - Δ phs , phc )}_{n} \vert}^{4} - {\vert {\sum }_{n = 0}^{N - 1} {r ( ϕ , E , phs + Δ phs , phc )}_{n} \vert}^{4} ]\end{matrix} ] .$$

The adaptive phase in this case will accommodate any additional frequency-dependent phase error at the interference carrier frequency, resulting in good interference nulling even with an unintentional phase error between the two loops at the desired signal. This is because the computation for dphs attempts to minimize the ISR, or more accurately maximize the SNIR without regard to the phase at the desired signal carrier frequency.

Two additional parameters E and phc must also be adapted when using the third E-field whip element. These additional parameters can be adapted in the same manner as was shown for p and phs. The expressions for the incremental adjustments for these parameters are presented below.

$$dE = 0.002 \cdot sign [ \begin{matrix}{\vert {\sum }_{n = 0}^{N - 1} {r ( ϕ , E - Δ E , phs , phc )}_{n} \cdot cos {vect}_{n} \vert}^{2} \cdot {\vert {\sum }_{n = 0}^{N - 1} {r ( ϕ , E + Δ E , phs , phc )}_{n} \vert}^{2} - \\ {\vert {\sum }_{n = 0}^{N - 1} {r ( ϕ , E + Δ E , phs , phc )}_{n} \cdot cos {vect}_{n} \vert}^{2} \cdot {\vert {\sum }_{n = 0}^{N - 1} {r ( ϕ , E - Δ E , phs , phc )}_{n} \vert}^{2} + \\ 0.01 \cdot [ {\vert {\sum }_{n = 0}^{N - 1} {r ( ϕ , E + Δ E , phs , phc )}_{n} \vert}^{4} - {\vert {\sum }_{n = 0}^{N - 1} {r ( ϕ , E - Δ E , phs , phc )}_{n} \vert}^{4} ]\end{matrix} ] . \\ dphc = 0.003 \cdot sign [ \begin{matrix}{\vert {\sum }_{n = 0}^{N - 1} {r ( ϕ , E , phs , phc - Δ phc )}_{n} \cdot cos {vect}_{n} \vert}^{2} \cdot {\vert {\sum }_{n = 0}^{N - 1} {r ( ϕ , E , phs , phc + Δ phc )}_{n} \vert}^{2} - \\ {\vert {\sum }_{n = 0}^{N - 1} {r ( ϕ , E , phs , phc + Δ phc )}_{n} \cdot cos {vect}_{n} \vert}^{2} \cdot {\vert {\sum }_{n = 0}^{N - 1} {r ( ϕ , E , phs , phc - Δ phc )}_{n} \vert}^{2} + \\ 0.01 \cdot [ {\vert {\sum }_{n = 0}^{N - 1} {r ( ϕ , E , phs , phc - Δ phc )}_{n} \vert}^{4} - {\vert {\sum }_{n = 0}^{N - 1} {r ( ϕ , E , phs , phc + Δ phc )}_{n} \vert}^{4} ]\end{matrix} ] .$$

Some smoothing, or filtering, of the adaptive parameters φ, phs and phc may be desirable (as shown in block 80) since these are somewhat noisy during the adaptation process; however, this noise was observed to be roughly 1 to 2 degrees before filtering, which may not significantly degrade performance. A single pole IIR filter (lossy integrator) with a time constant of about 30 symbols is effective in this case. The output signal is computed as shown in block 82 and sent to the receiver demodulator as shown in block 84.

The computations for the phase error adjustments phs and phc can be simplified if frequency-dependent phase error is not expected between the elements. Then a simpler expression can be used to adapt the phase of the carrier of the desired signal from the two loops.
dph=0.003 sign[Re{x}·Im{x}]
where

$$x = ( {\sum }_{n = 0}^{N - 1} {L}_{n} ) \cdot {( {\sum }_{n = 0}^{N - 1} {E}_{n} )}^{*}$$

and * denote complex conjugate.

This alternate expression for dph is not only simpler, but adapts more quickly to correct the phase error; although the quicker adaptation may not be important for overall performance. A combination of the two expressions for phase correction may further improve performance.

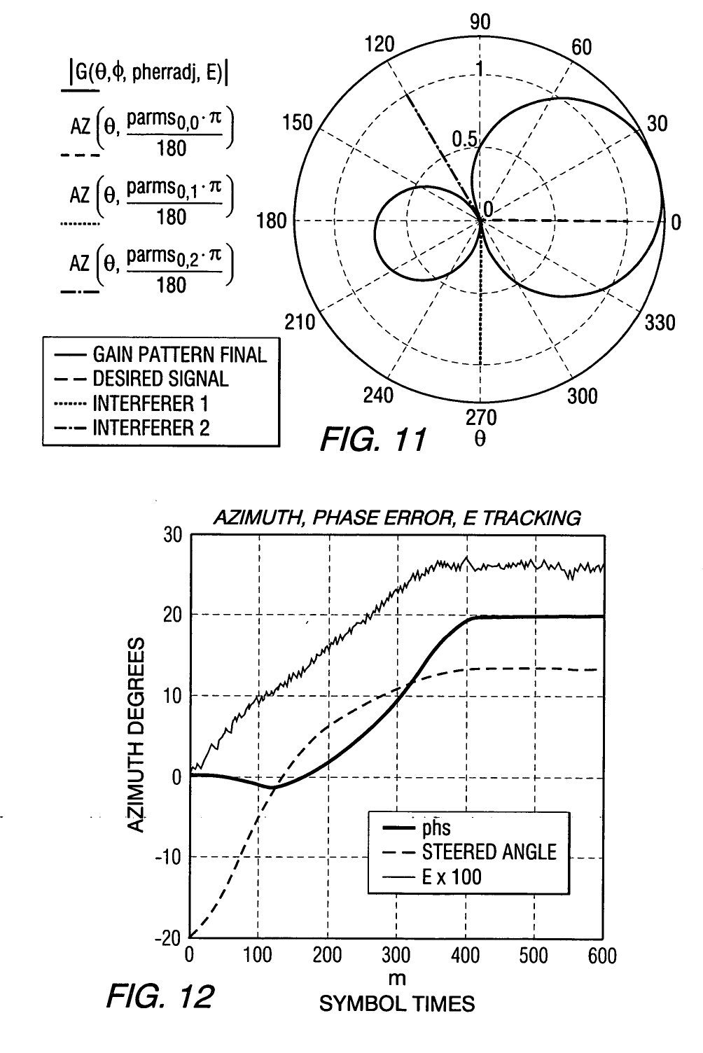

The beamforming algorithm was simulated and the results are shown in FIGS. 11 through 13. The optional simpler phase correction method was omitted for this simulation, in favor of the cost function using the derivative for the ISR reduction. The simulation included a desired signal at 0 dBc reference, arbitrarily placed at zero degrees in azimuth. Interferers included an upper first adjacent signal at +20 dBc at −90 degrees azimuth and a lower second adjacent signal at +20 dBc at 120 degrees azimuth. An arbitrary phase error of 20 degrees with 1 dB gain error was imposed on the signal from loop Ls as typical tolerances of the analog front end signals. The symbols are comprised of 270 samples each at a sample rate of about 46.5 kHz, typical of HD Radio™ signal processing.

FIG. 11 shows the final adapted beamforming pattern achieved after 600 symbol times, about 3.5 seconds. This figure shows that nulls were effectively formed in the direction of the interferers, while the gain toward the desired signal was increased.

FIG. 12 plots the progress of the adaptive beamforming parameters over the 600 symbol times. For this example 270 signal samples are used per symbol time period. The adaptive beamforming is updated every symbol period, or 270 samples.

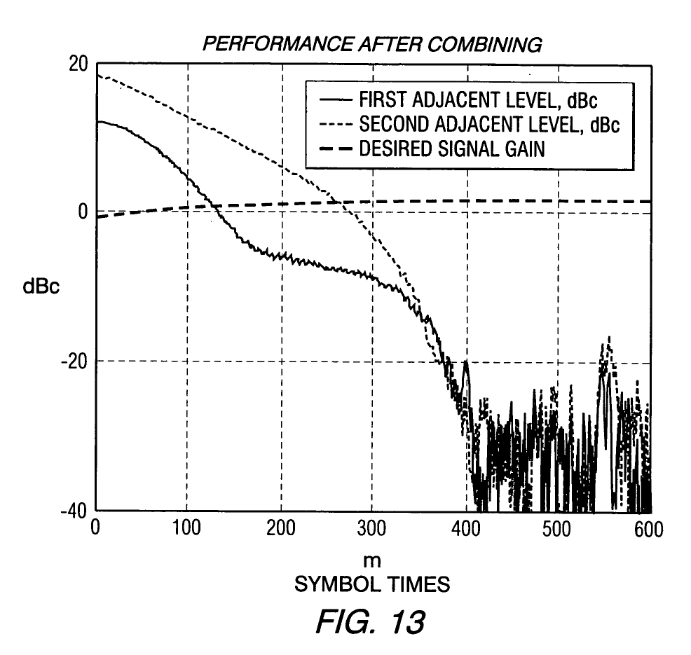

FIG. 13 shows the suppression of first and second adjacent interferers over adaptive beamforming period. In this case the interferer levels were effective nulled to about −30 dBc after the adaptation period.

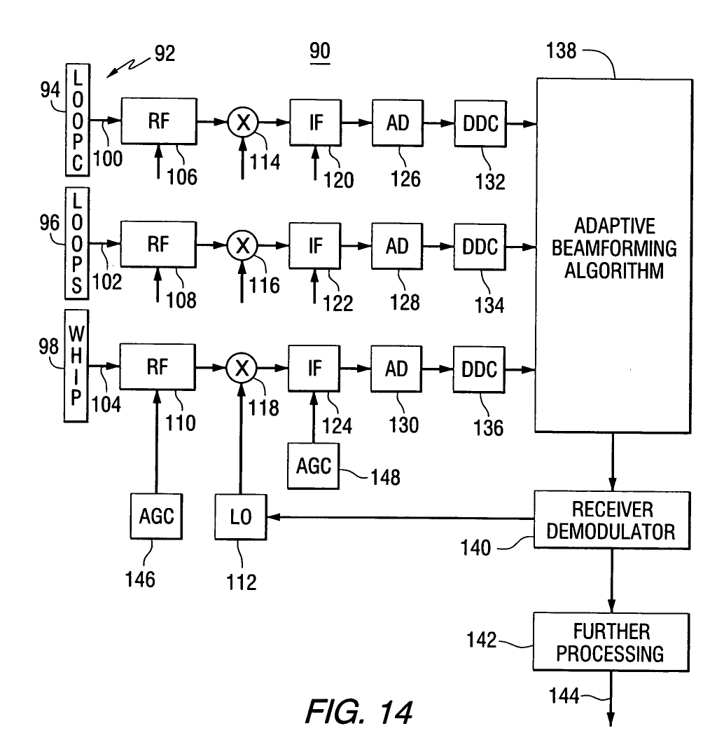

FIG. 14 is a block diagram of a receiver 90 constructed in accordance with one embodiment of the invention. An antenna 92 having two loop elements 94 and 96 and a whip element 98, produces signals on lines 100, 102 and 104. These signals are received by RF front end circuits 106, 108 and 110, and mixed with a local oscillator signal 112 in mixers 114, 116 and 118 to produce IF signals for circuits 120, 122 and 124. The IF signals are converted to digital signals as shown by analog-to-digital converters 126, 128 and 130 and down converted by digital down converters 132, 134 and 136. The signals are then subjected to an adaptive beamforming algorithm and described above and illustrated by block 138. The signals are combined and demodulated by demodulator 140 and subject to further processing as shown in block 142 to produce an output signal on line 144. Automatic gain control (AGC) 146 controls the gain of the RF circuits. Automatic gain control 148 controls the gain of the IF circuits. FIG. 14 shows a simplified functional block diagram of a receiver with three analog front ends.

AGC 148 controls the signal gain in the analog front end circuitry, which is typical in all receivers to prevent overload/underload, and keeps the signals within the dynamic range of the AID converters. This AGC control signal is common to all 3 input signals so that their relative gains are nearly constant. The combining is done as described in the adaptive beamforming algorithm, so that a single signal is presented to a conventional receiver.

The adaptive beamforming AM receiver requires two analog front ends when only the pair of crossed loops are used, and a third front end for the E-field whip element. The analog front ends in this example share a single local oscillator to ensure they are coherent at the tuned frequency, although an arbitrary phase error is acceptable. The A/D converters must be sampled synchronously, and the AGC control should also be shared to ensure gain stability during adaptation.

This is the conventional AGC found in all receiver front ends for dynamic range control, although one AGC “control” signal is generated to control all 3 signal paths with the same AGC gain. The details of generating this AGC signal are not shown, but one method would be to sum the signal levels of all three signals (either analog or digital means) and use this combined level to generate an AGC control signal.

This beamforming is designed to operate whether the signals are analog or IBOC; however, IBOC signals will often benefit more because of the increased possibility of interference due to its extended digital subcarriers in the 10 kHz to 15 kHz region.

While the invention has been described in terms of several embodiments, it will be apparent to those skilled in the art that various changes can be made to the described embodiments without departing from the scope of the invention set forth in the following claims.

What is claimed is:

1. A method of receiving an AM radio signal, the method comprising the steps of:
receiving the AM radio signal using a first loop antenna to produce a first received signal;
receiving the AM radio signal using a second loop antenna to produce a second received signal;
adjusting the relative gains of the first and second received signals to produce adjusted first and second signals;
combining the adjusted first and second signals;
demodulating the combined adjusted first and second signals; and
producing an output signal in response to the demodulated combined adjusted first and second signals.

2. The method of claim 1, further comprising the steps of:
receiving the AM radio signal using a whip antenna to produce a third received signal; and
demodulating the third signal in combination with the combined adjusted first and second signals to produce the output signal.

3. The method of claim 1, wherein the first and second loop antennas are positioned orthogonal to each other.

4. The method of claim 1, wherein the first and second received signals are processed using matched first and second front end circuits.

5. The method of claim 4, wherein the first and second front end circuits are coupled to a common local oscillator and a common automatic gain control signal.

6. The method of claim 1, further comprising the step of:
adjusting the relative phase of the first and second received signals to adjust a gain pattern of the first and second loop antennas and to produce the adjusted first and second signals.

7. The method of claim 1, further comprising the step of:
adaptively correcting phase error between the first and second received signals.

8. A receiver for receiving an AM radio signal, the receiver comprising:
a first front end circuit for receiving a first signal from a first loop antenna;
a second front end circuit for receiving a second signal from a second loop antenna;
a gain control for adjusting the relative gains of the first and second signals to produce adjusted first and second signals;
a demodulator for demodulating the adjusted first and second signals; and
processing circuitry for producing an output signal in response to the demodulated adjusted first and second signals.

9. The receiver of claim 8, further comprising:
a third front end circuit for receiving a third signal from a whip loop antenna, wherein the gain control adjusts the gain of the third signal, the demodulator demodulates the third signal in combination with the demodulated adjusted first and second signals to produce the output signal.

10. The receiver of claim 8, wherein the first and second loop antennas are positioned orthogonal to each other.

11. The receiver of claim 8, wherein the phase of the first and second signals is adjusted relative to an angle of arrival.

12. The receiver of claim 8, wherein the first and second front end circuits are matched.

13. The receiver of claim 8, wherein the first and second front end circuits are coupled to a common local oscillator and a common automatic gain control signal.

14. The receiver of claim 8, further comprising:
a phase control for adjusting the relative phase of the first and second received signals to adjust a gain pattern of the first and second loop antennas and to produce the adjusted first and second signals.

15. A method of receiving an AM radio signal, the method comprising the steps of:
initializing beamforming parameters to form a predetermined beam pattern;
retrieving a signal vector from at least two antenna elements;
computing a multidimensional gradient for a predetermined cost function around a most recent set of the beamforming parameters;
applying an incremental change to each beamforming parameter as a function of the gradient in a direction to minimize the cost function;
combining the signal vectors from the antenna elements as a function of the beamforming parameters; and
outputting the combined signal vectors.

16. The method of claim 15, wherein the cost function includes estimated relative adjacent subcarrier levels.

17. The method of claim 16, wherein the cost function further includes noise signal-to-noise ratio.

18. The method of claim 15, wherein the cost function includes a desensitizing factor.

19. The method of claim 15, wherein the cost function includes multiple desensitizing factors that can be adjusted for multiple interferers.

20. The method of claim 15, wherein the step of applying an incremental change to each beamforming parameter as a function of the gradient in a direction to minimize the cost function is proportional to the gradient.

21. A method of receiving an AM radio signal, the method comprising the steps of:
receiving the AM radio signal using a first loop antenna to produce a first received signal;
receiving the AM radio signal using a second loop antenna to produce a second received signal;
selecting a first one of the first and second received signals to produce an output;
monitoring the quality of the selected received signal;
comparing the quality to a predetermined threshold; and
if the quality is less than the predetermined threshold, selecting a second one of the first and second received signals to produce the output.

22. The method of claim 21, wherein the step of monitoring the quality of the selected received signal comprises the step of:
monitoring signal-to-noise or signal-to-interference ratio of the selected signal.

23. The method of claim 21, further comprises adding hysteresis to the selecting step.

24. A receiver for receiving an AM radio signal, the receiver comprising:
a first loop antenna for receiving the AM radio signal to produce a first received signal;
a second loop antenna for receiving the AM radio signal to produce a second received signal;
a switch for selecting a first one of the first and second received signals to produce an output; and
a processor for monitoring the quality of the selected received signal, for comparing the quality to a predetermined threshold, and if the quality is less than the predetermined threshold, for selecting a second one of the first and second received signals to produce the output.
